(19) United States
(12) Patent Application Publication
(10) Pub. No.: US 2016/0275265 A1
(43) Pub. Date: Sep. 22, 2016

(54) System and Method for Identifyiing Healthcare Professionals

(71) Applicant: IMS Health Incorporated, Danbury, CT (US)

(72) Inventors: Alexander Staus, Frankfurt (DE); Agnieszka Wolk, Frankfurt Am Main (DE)

(21) Appl. No.: 14/658,966

(22) Filed: Mar. 16, 2015

(51) Int. Cl. G06F 19/00

(52) U.S. Cl. CPC G06F 19/3456

(57) ABSTRACT

A computer-assisted method to identify healthcare professionals, the method including: receiving prescription data including records, each record encoding information identifying a pharmaceutical product and a healthcare professional, information referring to a patient recipient, information indicating a time when the prescription was filled, the records devoid of information identifying patient recipients; extracting, from the received prescription data, records of more than one healthcare professionals; analyzing the extracted records of each healthcare professional to rank the more than one healthcare professionals by: determining, from the extracted records, a prescription volume for each healthcare professional; generating, for each healthcare professional, a summary prescription pattern of patient recipients receiving prescriptions from the healthcare professional; and classifying each healthcare professional according to the generated summary prescription pattern; and providing, on a display device in communication with the one or more processors, information indicating at least one of the ranked healthcare professionals.

### BACKGROUND

Healthcare professionals, such as physicians, may prescribe healthcare products, such as prescription medications, to patients.

### OVERVIEW

In one aspect, some implementations provide a computer-implemented method that included: receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, information indicating a time when the prescription was filled, the records devoid of information identifying patient recipients; extracting, from the received prescription data, records of more than one healthcare professionals; analyzing, by one or more processors coupled to the one or more database systems, the extracted records of each healthcare professional to rank the more than one healthcare professionals by: determining, from the extracted records, a prescription volume for each healthcare professional; generating, for each healthcare professional, a summary prescription pattern of patient recipients receiving prescriptions from the healthcare professional; and classifying each healthcare professional according to the generated summary prescription pattern; and providing, on a display device in communication with the one or more processors, information indicating at least one of the ranked healthcare professionals.

Implementations may include one or more of the following features. Generating the summary prescription pattern for each healthcare professional further may include longitudinally linking, for each patient recipient who received prescriptions from the healthcare professional, records as extracted from the prescription data from the one or more database systems, wherein the prescriptions were received by the patient recipient at various times. Generating the summary prescription pattern for each healthcare professional may further include: determining a respective usage pattern of each of the more than one patient recipients based on the linked records for more than one patient recipients who received prescriptions from the healthcare professional; and generating the summary prescription pattern for the healthcare professional based on the aggregate usage patterns determined for the more than one patient recipients who received prescriptions from the healthcare professional. Determining a respective usage pattern of a particular patient recipient may further include: determining whether the particular patient recipient is refilling a pharmaceutical product. Determining a respective usage pattern of a particular patient recipient may further include: determining whether the particular patient recipient switched from a first pharmaceutical product to a second pharmaceutical product. Determining a respective usage pattern of a particular patient recipient may further include: determining whether the particular patient recipient supplemented a first pharmaceutical product with a second pharmaceutical product. Determining a respective usage pattern of a particular patient recipient may further include: determining whether the particular patient recipient received a pharmaceutical product from a given therapeutic class that the particular patient recipient had not previously received. Analyzing the extracted records of each healthcare professional to rank more than one healthcare professionals may further include: determining a first group of patient recipients who received prescriptions from a first healthcare professional; determining a second group of patient recipients who received prescriptions from a second healthcare professional, wherein the first and second healthcare professional are different from each other and both are from the more than one healthcare professionals being ranked; and determining whether the first group overlaps with the second group. The method may further include: in response to determining that the first group overlaps with the second group, determining a number of patient recipients in both the first group and the second group.

Analyzing the extracted records of each healthcare professional may further include: determining whether the healthcare professional is likely to use a newly launched healthcare product. Determining whether the healthcare professional is likely to use a newly launched healthcare product may further include: determining whether the healthcare professional has used the newly launched healthcare product. Determining whether the healthcare professional is likely to use a newly launched healthcare product may further include: determining whether the healthcare professional has used the newly launched healthcare product more often than at least one other healthcare professional.

In another aspect, some implementations provide a computer system comprising one or more processors, configured to perform the operations of: receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, information indicating a time when the prescription was filled, the records devoid of information identifying patient recipients; extracting, from the received prescription data, records of more than one healthcare professionals; analyzing, by one or more processors coupled to the one or more database systems, the extracted records of each healthcare professional to rank the more than one healthcare professionals by: determining, from the extracted records, a prescription volume for each healthcare professional; generating, for each healthcare professional, a summary prescription pattern of patient recipients receiving prescriptions from the healthcare professional; and classifying each healthcare professional according to the generated summary prescription pattern; and providing, on a display device in communication with the one or more processors, information indicating at least one of the ranked healthcare professionals.

Implementations may include one or more of the following features. Generating the summary prescription pattern for each healthcare professional further may include longitudinally linking, for each patient recipient who received prescriptions from the healthcare professional, records as extracted from the prescription data from the one or more database systems, wherein the prescriptions were received by the patient recipient at various times. Generating the summary prescription pattern for each healthcare professional may further include: determining a respective usage pattern of each of the more than one patient recipients based on the linked records for more than one patient recipients who received prescriptions from the healthcare professional; and generating the summary prescription pattern for the healthcare professional based on the aggregate usage patterns determined for the more than one patient recipients who received prescriptions from the healthcare professional.

Determining a respective usage pattern of a particular patient recipient may further include: determining whether the particular patient recipient is refilling a pharmaceutical product. Determining a respective usage pattern of a particular patient recipient may further include: determining whether the particular patient recipient switched from a first pharmaceutical product to a second pharmaceutical product. Determining a respective usage pattern of a particular patient recipient may further include: determining whether the particular patient recipient supplemented a first pharmaceutical product with a second pharmaceutical product. Determining a respective usage pattern of a particular patient recipient may further include: determining whether the particular patient recipient received a pharmaceutical product from a given therapeutic class that the particular patient recipient had not previously received. Analyzing the extracted records of each healthcare professional to rank more than one healthcare professionals may further include: determining a first group of patient recipients who received prescriptions from a first healthcare professional; determining a second group of patient recipients who received prescriptions from a second healthcare professional, wherein the first and second healthcare professional are different from each other and both are from the more than one healthcare professionals being ranked; and determining whether the first group overlaps with the second group. The operations may further include: in response to determining that the first group overlaps with the second group, determining a number of patient recipients in both the first group and the second group.

Analyzing the extracted records of each healthcare professional may further include: determining whether the healthcare professional is likely to use a newly launched healthcare product. Determining whether the healthcare professional is likely to use a newly launched healthcare product may further include: determining whether the healthcare professional has used the newly launched healthcare product. Determining whether the healthcare professional is likely to use a newly launched healthcare product may further include: determining whether the healthcare professional has used the newly launched healthcare product more often than at least one other healthcare professional.

In yet another aspect, some implementations provide a computer-readable medium, comprising software instructions, which when executed by a processor of a computer, causes the computer to perform the operations of: receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, information indicating a time when the prescription was filled, the records devoid of information identifying patient recipients; extracting, from the received prescription data, records of more than one healthcare professionals; analyzing, by one or more processors coupled to the one or more database systems, the extracted records of each healthcare professional to rank the more than one healthcare professionals by: determining, from the extracted records, a prescription volume for each healthcare professional; generating, for each healthcare professional, a summary prescription pattern of patient recipients receiving prescriptions from the healthcare professional; and classifying each healthcare professional according to the generated summary prescription pattern; and providing, on a display device in communication with the one or more processors, information indicating at least one of the ranked healthcare professionals.

The details of one or more aspects of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A illustrates an example of a system for deriving pharmaceutical prescription data from various data supplier sites such as pharmacies.

FIG. 1B illustrates an example of a system for aggregating prescription data from data servers at pharmacies longitudinally tracking the prescription pattern of human patients.

FIG. 1C illustrates an example of linking prescription data of the patients.

FIG. 2A illustrates an example of combining data analytics based on the linked prescription data from various pharmacies.

FIG. 2B illustrates an example of determining a summary prescription pattern of a healthcare professional based on the usage pattern of patients of this healthcare professional.

FIG. 2C illustrates an example of patient networks of four healthcare professionals.

FIGS. 3A-3B show various aspects of an example of a process for identifying a healthcare professional.

FIG. 4A shows an example of summarizing and comparing patient network information of healthcare professionals.

FIGS. 4B-4C show an example of the summary prescription volumes of healthcare professionals for healthcare products in various market segments over the course of time.

FIGS. 4D-4E show an example of the categorized summary prescription pattern of healthcare professionals and over the course of time.

FIG. 4F illustrates an example of the usage patterns of patients of a particular healthcare professional.

FIG. 4G is an example of a flow chart for deriving usage pattern for patients based on linked prescription data.

FIG. 4H shows an example of a table tabulating tracked usage pattern of patients for using healthcare products.

Like reference symbols in the various drawings indicate like elements.

### DETAILED DESCRIPTION

This disclosure generally describes a system and a method for providing data analytics to identify healthcare professionals with prescription characteristics suited for targeted marketing initiatives. In some implementations, pharmacy data are collected from data servers at pharmacies that records the filled prescription information for patients. The information generally identifies a pharmaceutical product such as a prescription drug and a healthcare professional such as the prescribing physician. The information also refers to a de-identified patient recipient. The de-identification means no identity information, such as name, address, birth date, or social security information, is available in the recorded information. Instead, each patient recipient is referenced by an anonymous tag that is specific to the patient recipient. Generally, the anonymous tag is doubly encrypted using a key specific to a data supplier (such as a data server at a pharmacy) and another key specific to a longitudinal database. Interestingly, pharmacy data from pharmacies (for example, those participating in insurance coverage) can be coalesced for each individual healthcare professional, such as each prescribing physician. The coalesced pharmacy data for a particular healthcare professional includes prescription data of patients who received prescriptions from the healthcare professional. The prescription pattern for each healthcare professional can be analyzed in a number of aspects. In one aspect, the prescription volume, for example, total number of prescriptions measured in dosages, can be obtained by summing up the prescription data for each healthcare product prescribed by the healthcare professional. In another aspect, the summary prescription pattern can be built on individual usage data from all patients who received prescription from the healthcare professional. In this aspect, the individual usage data may be derived by analyzing the prescription records for each individual patient recipient after, for example, the prescription records for each individual patient recipient are linked based on the anonymous tag. The analysis can be performed for each category of healthcare product the patient has received, each prescription drug within the product category that the patient has received, or each dosage level for the particular prescription drug. The individual usage data from all patients of the particular healthcare professional can be statistically analyzed to reveal a characteristic of the healthcare professional. This characteristic generally relates to a dynamic nature of the healthcare professional's prescribing tendency. In yet another aspect, the network of patients of more than one healthcare professionals can be compared to determine any overlap, and if so, the extent of the overlap. In still yet another aspect, the prescription record of all prescriptions by a particular healthcare professional can be analyzed to determine a likelihood of the healthcare professional to prescribe newer yet less tested pharmaceutical products. The above analysis on all four aspects may be combined to arrive at a more comprehensive determination to rank more than one healthcare professionals. The ranked results may be displayed on a display device of the data analytics system so that information about highly ranked healthcare professionals is presented, with detailed break-down scores in each of the four analyzed aspects.

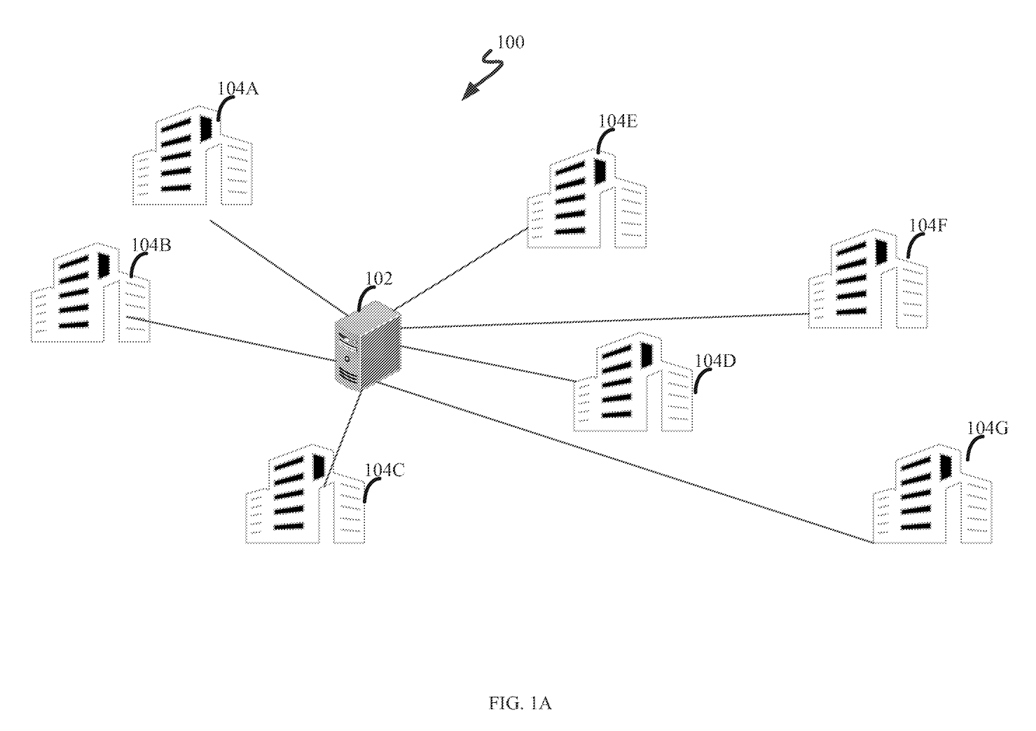

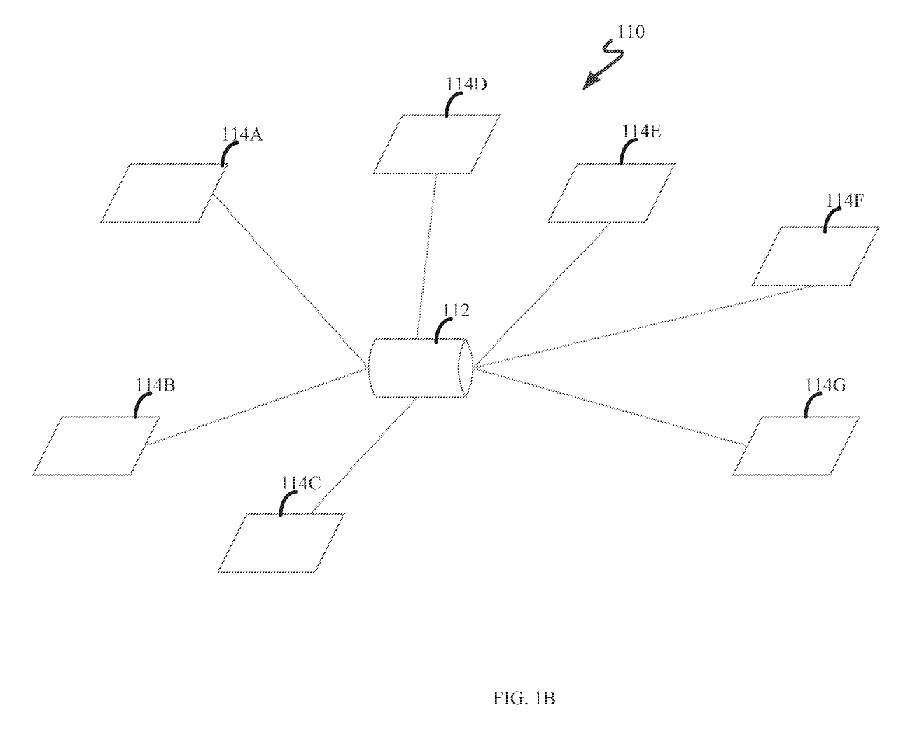

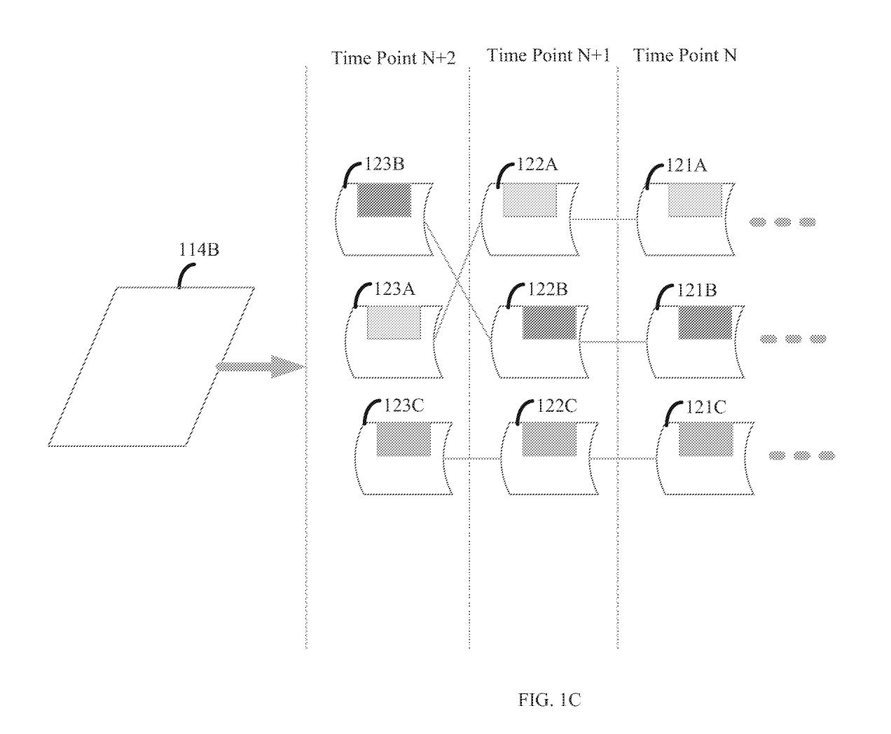

FIG. 1A illustrates an example system 100 for providing data analytics to identify healthcare professionals with prescription characteristics suited for targeted marketing initiatives. The healthcare professional may include a person authorized to write a prescription for a patient. The healthcare professional can be a physician, or a nurse. The prescription may include a pharmaceutical product such as a prescription drug approved by a regulatory agency, such as the Federal Drug Administration (FDA), the European Medicines Agency (EMA), the Medicines and Healthcare products Regulatory Agency (MHRA). The pharmaceutical product can also include approved medical devices. The prescriptions may be filled at multiple sites, such as pharmacies 104A to 104G. These sites can cover a geographic region, for example, a region in a particular country. These sites may also be located globally, for example, the North American continent, or the European Union.

Prescription data for each participant patient may be collected from each pharmacy store. In one example, a pharmacy database may collect prescription data from all pharmacy stores on a daily basis. The pharmacy database includes non-volatile data storage devices. Each pharmacy store may house its own data server in communication with the pharmacy database to transfer prescription data on a daily basis. The prescription data records the information about a particular prescription when the prescription was filled. As disclosed herein, the prescription data for each participant patient, as recorded at the pharmacy store at the time of filling, is de-identified such that the data does not include information capable of identifying the particular participant patient. Examples of such identifying information include: patient's name, patient's insurance identification number, patient's Medicare/Medicaid identification number, patient's social security number, patient driver's license number, etc. In some implementations, such identifying information may be converted by a one-way hash-function to generate an alpha-numerical string. The alpha-numerical string conceals the identity of the individual participant patient, thereby maintaining confidentiality of the data as the data is being reported, for example, daily from the sites 104A to 104G to the central server 102. There, data corresponding to the same participant patient may be linked by virtue of the matching alpha-numerical string. Thus, data for the same participant patient may be longitudinally tracked as the for each individual, without compromising confidentiality of the individual patients, even though the patient can fill the prescription at various stores and the patient can receive a prescription for a healthcare product from various healthcare professionals.

FIG. 1B illustrates an example work flow 110 for collecting data of patient recipients from data servers at various pharmacy stores and longitudinally tracking the prescription record of each individual patient recipient over time. Data 114A-114G may correspond to prescription data reported from each pharmacy store. In some implementations, data 114-114G may be reported from data servers at each pharmacy store on a daily basis, for example, at the end of business data local time. Data 114A-114G remain de-identified to preserve confidentiality, as disclosed herein. In this illustrated work flow, each pharmacy store may employ the same one-way hashing function to anonymize data records of each patient. As a result, reported prescription data 114A-114G, as received at central server 102 to update database 112, include the same de-anonymized key for prescription records from the same patient, even if the patient may move to another pharmacy store, another healthcare professional, or another healthcare provider (e.g., health insurance carrier, pharmacy insurance carrier). The central server 102 may match prescription data records from the same patient recipient to update database 112, which contains data records reported earlier for the same patient recipient.

In some implementations, however, the de-identified data may be further encrypted before the data is reported to central server 102 to update database 112. For illustration, data 114A-114G may be encrypted using a symmetric encryption key specific to each pharmacy store. The symmetric encryption key may only be known to the pharmacy store and central server 102. Thus, only the participant site can encrypt the de-identified data with the symmetric key and only the central server 102 can decrypt the encrypted de-identified data with the particular symmetric key. In another illustration, a public-key infrastructure (PKI) may be used such that the reported data may be encrypted with the public key of the central server 102 so that only the central server 102 can decrypt using its private key. In other illustrations, the central server 102 and pharmacies 104A-104G may exchange messages using the PKI to establish an agreed-on symmetric key.

FIG. 1C illustrates an example linkage of daily reported prescription data for the patient recipients based on matching anonymized tags. As illustrated, the daily received prescription data (for example, data 114B from pharmacy 104B) correspond to patient recipients. The de-identification process allows such prescription data to remain anonymous. In some implementations, the de-identified data from the same patient may be linked at central server 102. As illustrated, data are received on different days for the patient recipients. For example, on time point N, de-identified prescription data 121A to 121C may be received. Likewise, on time point N+1, de-identified prescription data 122A to 122C are received. Similarly, on time point N+2, de-identified data 123A to 123C may be received. These de-identified prescription data correspond to different patient recipients. Based on matching tags, such as matching de-identified alpha-numerical strings, the de-identified prescription data from each patient recipient may be linked and hence the prescription activity of a particular patient recipient can be longitudinally tracked. In some implementations, the matching tags may include graphic representations as well as alpha-numerical strings. The graphic representations are also de-identified to remove personally identifiable information of the participant patient. In some instances, the alpha-numerical strings or graphical representations may be tags to the actual prescription data record, which may be referred to as part of the metadata. In other instances, the alpha-numerical strings or graphical representations may be embedded to the actual prescription data record itself. In still other instances, the alpha-numerical strings or graphical representations may be part of the metadata and embedded in the actual prescription data record. The implementations of both the tag and the embedding may further deter alterations or modifications of the data records being reported from each participant site. When the received daily data records are linked with earlier data records of the same patient recipients, database 112 may be updated. The updated database may allow a variety of data analytics to be generated, revealing the interesting insights of prescription usage pattern for each patient recipient as well as the statistical prescription pattern of each healthcare professional, as discussed below.

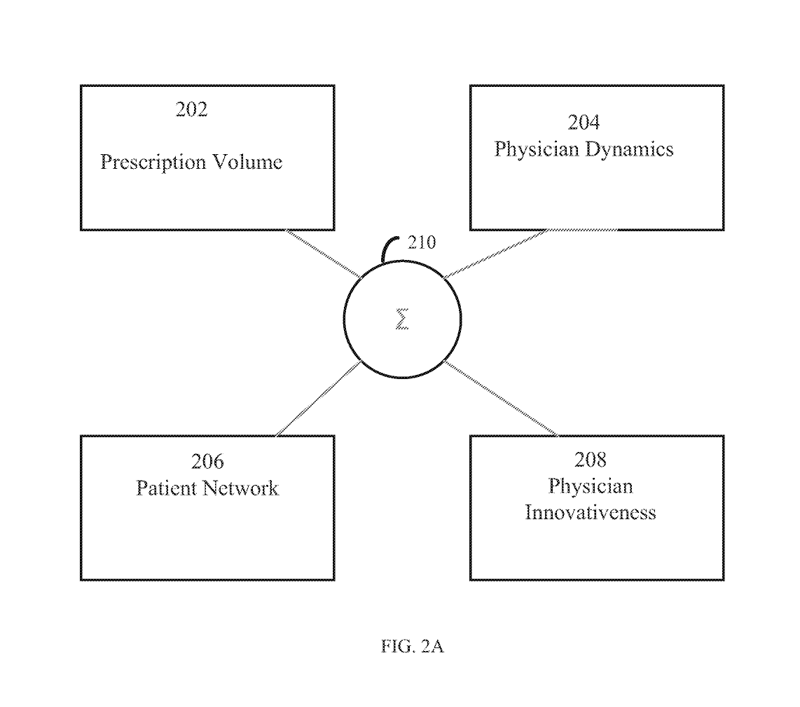

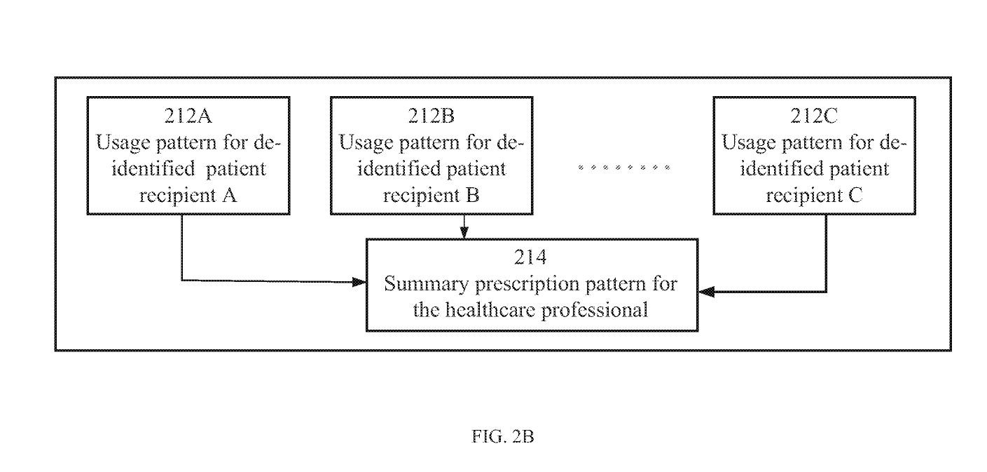

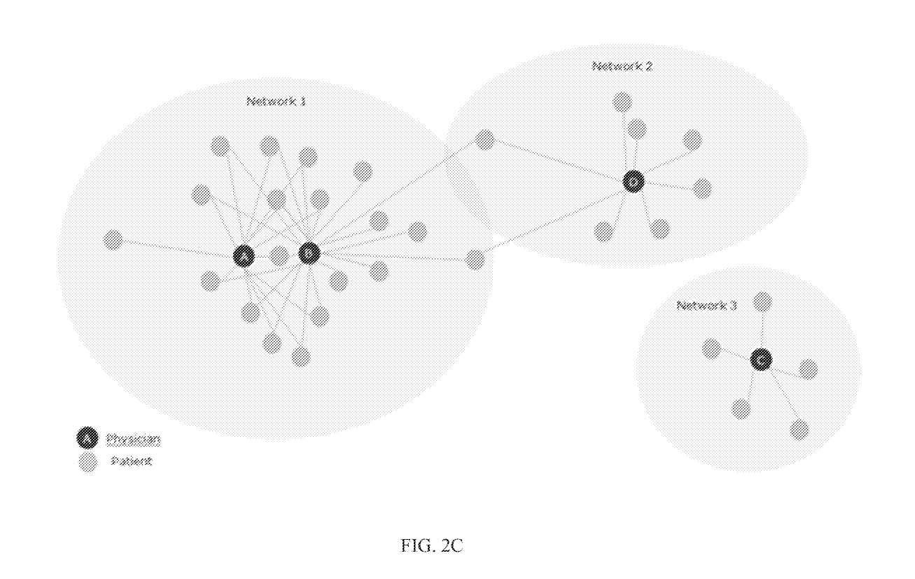

FIG. 2A illustrates an example of combining data analytics based on the linked prescription data from various pharmacies. Initially, prescription data is received at a data server, such as central server 112. The received prescription data is anonymous with respect to each patient recipient. Yet, the prescription data records the filled prescription information for each patient recipient. The filled prescription information generally identifies a pharmaceutical product such as a prescription drug and a healthcare professional such as the prescribing physician. The filled prescription information for each patient recipient can be longitudinally linked based on, for example, an anonymous tag specific to a particular patient recipient.

Prescription volume for a particular healthcare professional may be obtained from the longitudinally linked prescription records (202). For example, by combining the dosage level for each patient recipient who receives a prescription for a particular healthcare product from a particular healthcare professional, prescription volume of the particular healthcare product can be determined for the particular healthcare professional. Similarly, by combining the dosage level for each patient recipient who receives a prescription for healthcare products of a particular market segment (for example, the therapeutic area of hypertension) from a particular healthcare professional, prescription volume of the particular healthcare professional can be determined with regard to this market segment.

The dynamic character of a particular healthcare professional can also be determined by analyzing the longitudinally linked prescription records (204). In some instances, the summary prescription pattern of the particular healthcare professional can be determined based on individual usage data from all patients who received prescription from the healthcare professional. In these instances, the individual usage data of each individual patient recipient of the healthcare professional may be obtained by analyzing the linked prescription record for the individual patient recipient. Referring to FIG. 2B, usage pattern 212A to 212C can be derived for patient recipients A to C, respectively. The usage patterns can include the track record (for example, the dosage record, records of intermissions) of using a particular prescription drug. This can include, for example, dosage escalation or tapering off. The usage patterns can include the track record of using a particular class of prescription drugs (e.g., using an anti-depressant drug for the first time, switching from one statin drug such as Zocor to another statin drug such as Liptor). The usage patterns can be analyzed for each category of healthcare product the patient has received, each prescription drug within each category the patient has received, or each dosage level for each prescription drug. The analysis can be joined to derive summary prescription pattern of the particular healthcare professional (214). Here, the individual usage data from all patients of the particular healthcare professional can be statistically combined to reveal a characteristic of the healthcare professional. This characteristic generally relates to a dynamic nature of the patient recipients as well as the healthcare professional's prescribing tendency. For example, patient recipients can be classified into static patients (patients who continue their therapy without changes in their prescription drug or dosage) and dynamic patients (patients who are new or patients who change or adjust their therapy, including prescription drugs or dosage levels). Physicians with high proportion of dynamic patients (e.g. more than 30% of the patient pool) may be considered as dynamic physicians who initiate therapy, change the therapy or adjust therapy by prescribing add-on drugs. Dynamic physicians (e.g., decision makers) are of higher relevance for targeting than static physicians.

Returning to FIG. 2A, the network of patients of healthcare professionals can be analyzed. For example, the patient networks of more than one healthcare professionals may be compared to determine any overlap, and if so, the extent of the overlap. Referring to FIG. 2C, patient networks of physicians A, B, C, and D are presented in graph mode. Here, physicians A and B share a large portion of their patient networks (network 1). In some instances, for example, when common nodes of patients make up more than 50% of the average size of the patient networks of the two healthcare professionals, the two patient networks can be determined as duplicative. Meanwhile, the overlap between the patient network (network 2) of physician C and those of A or B is relatively modest. Further, physician D enjoys patient network 3 that has no noticeable overlap with either network 1 or network 2. For targeting purposes, it would be sufficient to visit one physician from network 1. With this single visit, all patients from the network may be reached. Visiting additional physicians from network 1 may not improve patient reach in the marketing initiative.

Returning to FIG. 2A, the prescription record of all prescriptions by a particular healthcare professional can be analyzed to determine an innovative index of the healthcare professional (208). This index can determine the likelihood of the healthcare professional to prescribe newly launched drugs, or new indications (for example, off-label indications). In more detail, visibility of physician prescribing pattern allows for quantifying the proportion of newly launched products in their prescribing portfolio. For targeting purposes, physicians with higher innovative indices can be receptive to newly launched drugs, newly approved indications, or new off-label indications.

In some instances, prescription volume 202, physician dynamics 204, patient network 206, and physician innovativeness 208 may be combined (210). The combination may first score each of prescription volume 202, physician dynamics 204, patient network 206, and physician innovativeness 208. The combination may then assign weights to all four aspects to arrive at a more comprehensive determination to rank more than one healthcare professionals. The ranked results may be displayed on a display device of the data analytics system so that information about highly ranked healthcare professionals is presented, with detailed break-down scores in each of the four analyzed aspects. In particular, this ranking is based on a comprehensive and holistic analysis derived from more than one aspects. Such ranking reveals more insights and provides richer details in profiling the prescription behavior of each individual healthcare professional.

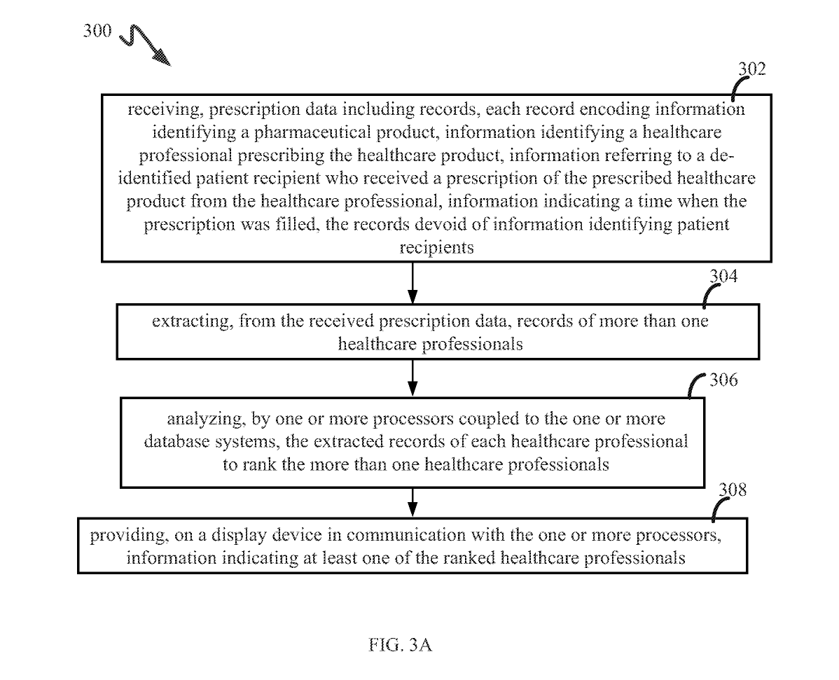

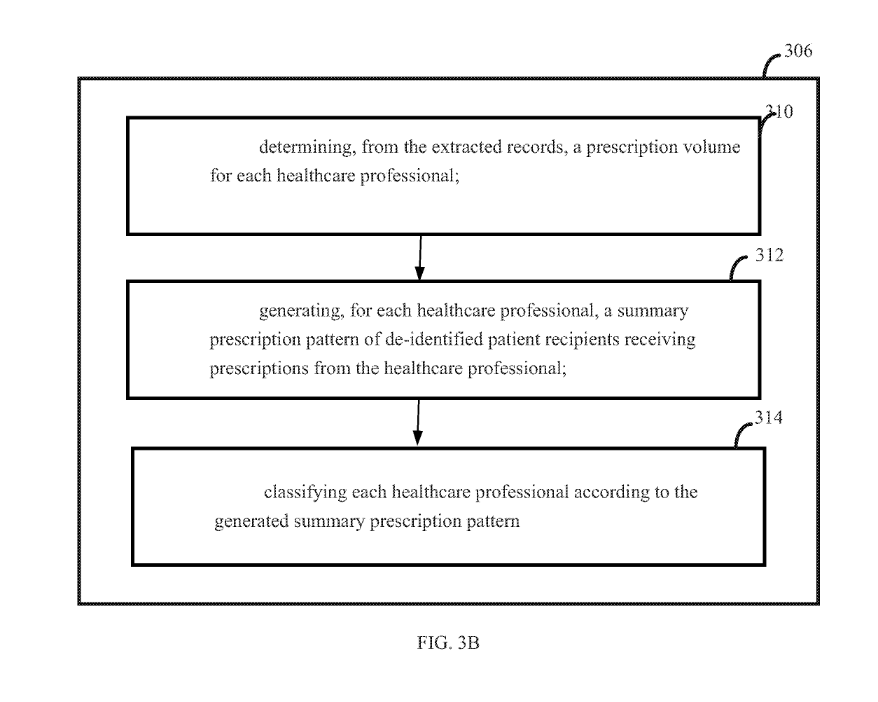

FIG. 3A shows an example of a flow chart for identifying a healthcare professional. Initially, prescription data including records is received (302). Each record may encode information identifying a pharmaceutical product, information identifying a healthcare professional prescribing the healthcare product, information referring to a de-identified patient recipient who received a prescription of the prescribed healthcare product from the healthcare professional, and information indicating a time when the prescription was filled. The records is devoid of information identifying patient recipients

Thereafter, records of more than one healthcare professionals may be extracted from the received prescription data (304). The extraction may group prescription data records based on the identity of the prescribing physician on the filled prescription form. In some instances, while prescription data records include identity information of the prescribing physician (e.g., physician tax ID), the extraction process can combine prescription data records corresponding to the same prescribing physician.

Next, the extracted records of each healthcare professional are analyzed to rank the more than one healthcare professionals (306). For example, the analysis can be done by one or more processors coupled to the one or more database systems that houses the extracted prescription data records. Referring to FIG. 3B, the analysis may include determining, from the extracted records, a prescription volume for each healthcare professional (310). The analysis may include determining, from the extracted records, a prescription volume for each healthcare professional (310). The analysis may also include generating, for each healthcare professional, a summary prescription pattern of de-identified patient recipients receiving prescriptions from the healthcare professional (312). As discussed herein, the summary prescription pattern for a particular healthcare professional can be statistically determined based on the usage data for all de-identified patient recipients who received prescriptions from the healthcare professional. The analysis may further include classifying each healthcare professional according to the generated summary prescription pattern (314). As discussed herein, the classification may reveal a dynamic nature of the healthcare professional depending on the composition characteristics of the patient recipients who received prescriptions from the healthcare professional.

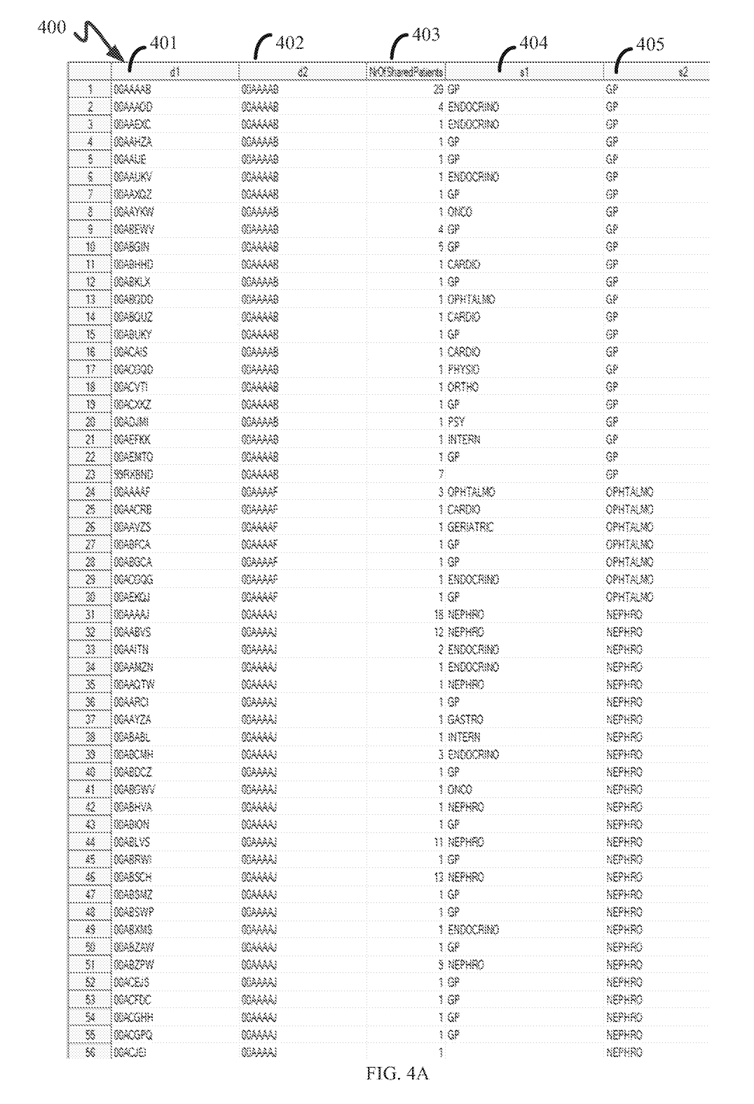

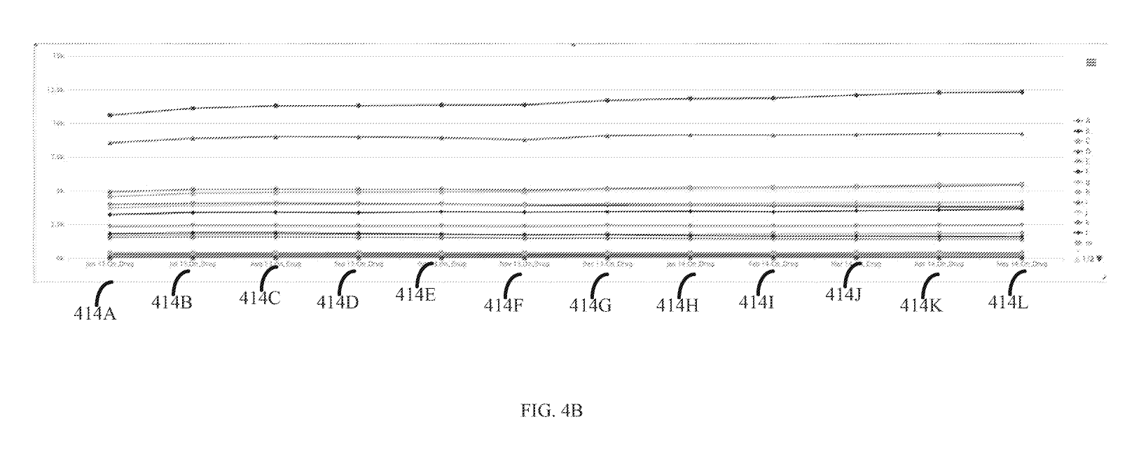

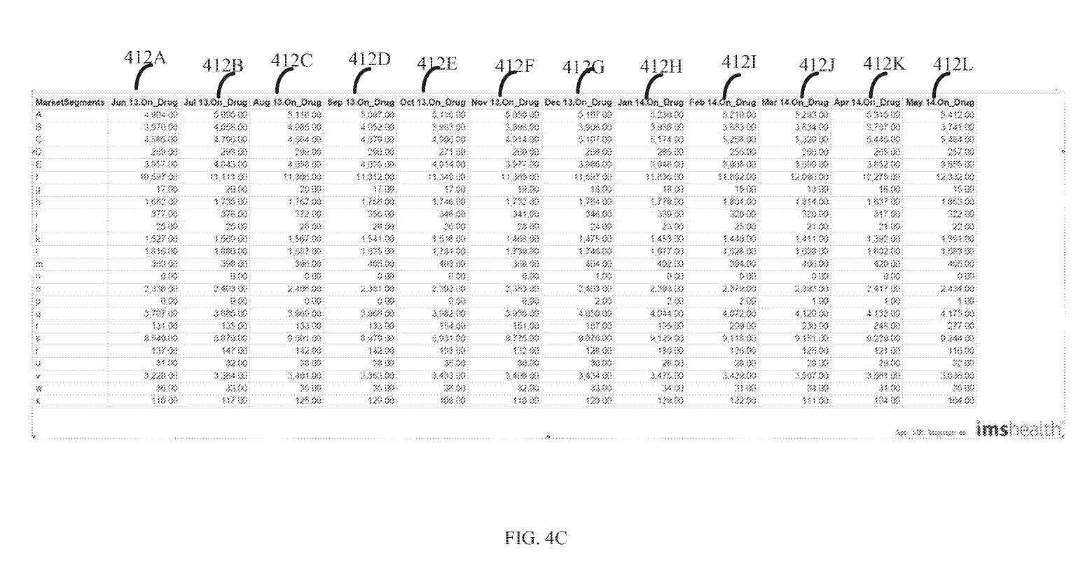

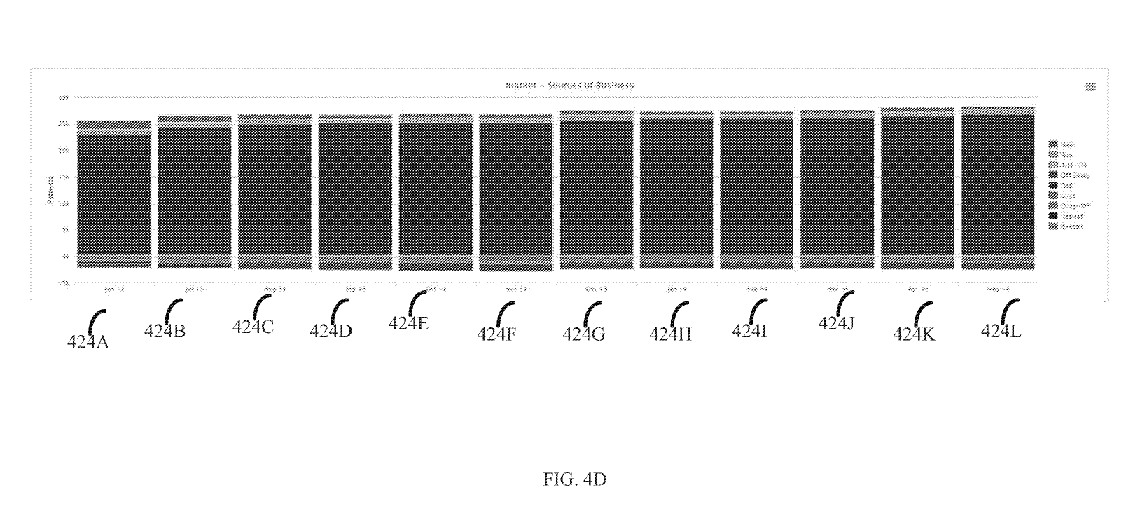

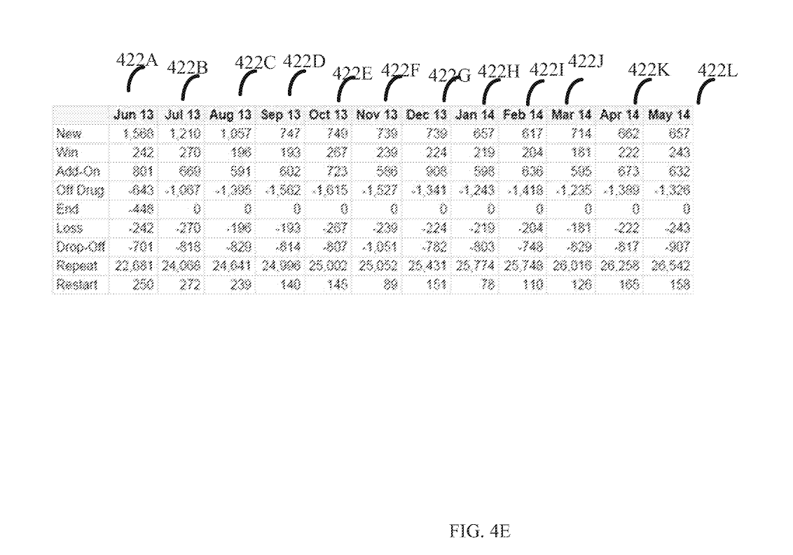

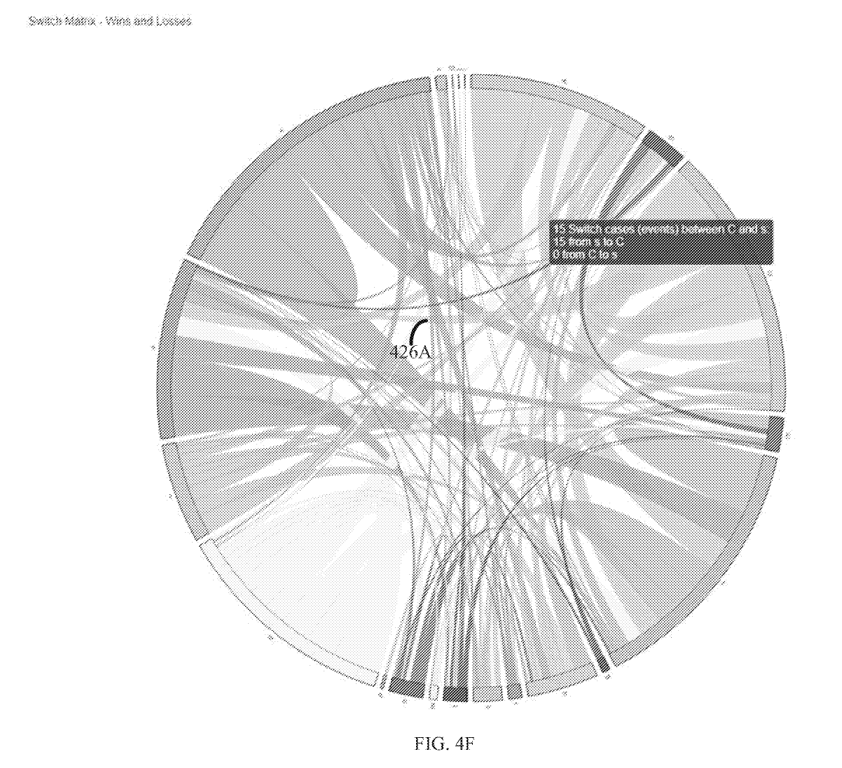

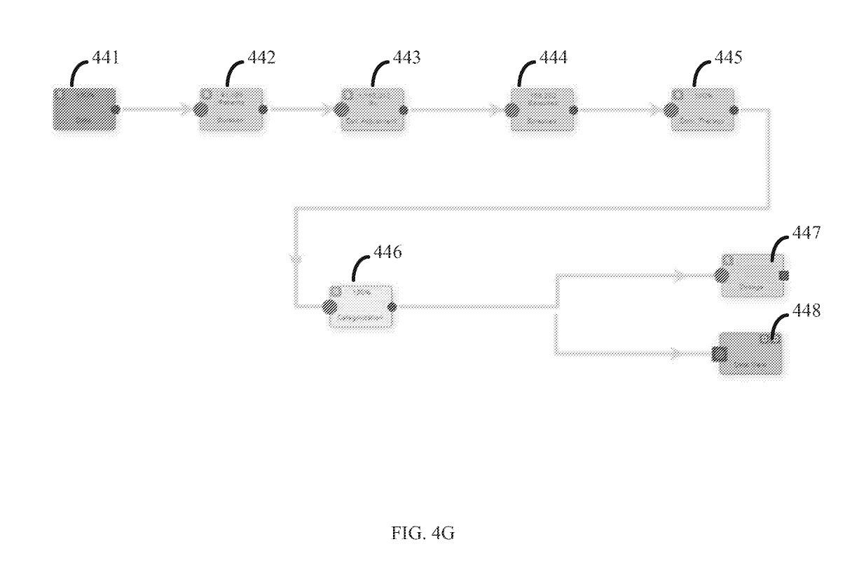

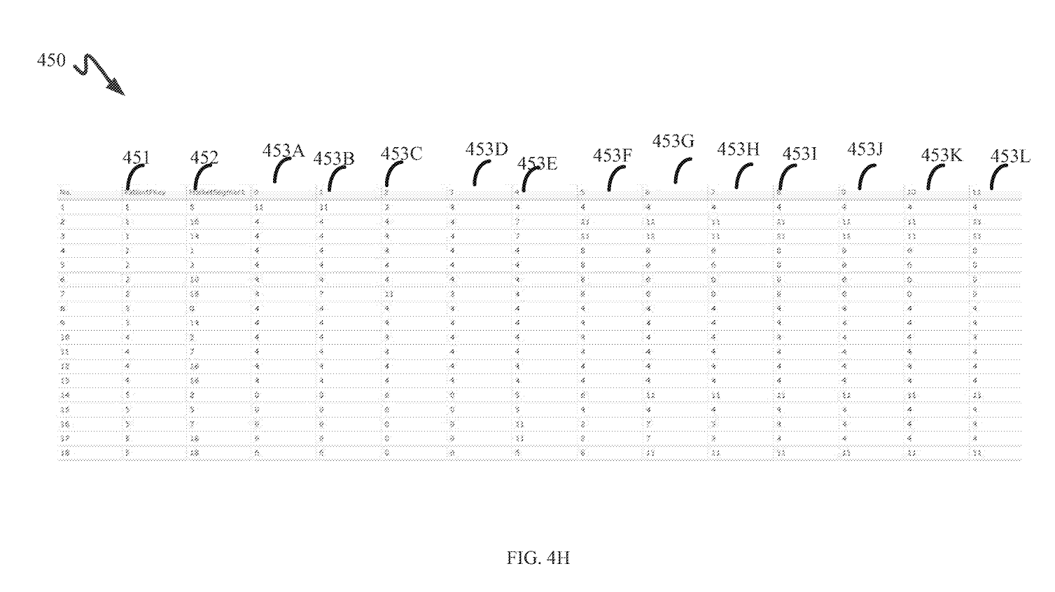

Referring to FIG. 4A, user interface 400 shows a table comparing the patient networks of physicians 401 and 402. As illustrated, physicians 401 has a specialty 404 while physician 402 has a specialty 405. The size of the overlap of their patient networks is shown in 403.

FIGS. 4B-4C shows an example of summary prescription volumes of particular healthcare professionals for healthcare products in various market segments over the course of time. In more detail, the summarized prescription volumes are tabulated in FIG. 4C at time points 412A to 412L for market segments A through X. Here, market segments may refer to a particular therapeutic area (such as cardiovascular, inflammation). FIG. 4B, on other hand, charts the summarized prescriptions volumes at time points 414A to 414L, that are identical to time points 412A to 412L.

FIGS. 4D-4E shows an example of categorized summary prescription pattern of particular healthcare professionals and over the course of time. In particular, the changes in the number of patient recipients for each category is tabulated in FIG. 4D for time points 422A to 422L. The categories include new, win, add-on, off-drug, end, loss, drop-off, repeat, and restart. The category of new refers to the class when patients indicate that they have not received a prescription drug from a specified therapeutic area yet. The win category refers to the situation in which patients are switching to the prescription drug from another prescription drug. The add-on category means whether the patients are supplemented with a prescription drug. The off-drug category represent when patients are no longer taking the drug or no longer on therapy. The end category indicates whether patients are ending their prescription of the drug. The loss category indicates whether the patients are getting off the prescription drug for another prescription drug, representing a loss of prescriptions for the prescription drug. Drop-off means whether the patients are drop-off the prescription drug. Repeat means whether the patients are merely refilling their existing prescriptions. Restart means whether the patients are starting the prescription after a hiatus. FIG. 4E presents the categorized summary prescription patterns as composition charts at time points 424A to 414L, that are identical to time points 422A to 422L. The composition charts are based on the same categories as in FIG. 4D.

More interestingly, FIG. 4F illustrates an example of usage patterns of patients of particular healthcare professionals. To highlight the categories discussed above, each pharmaceutical product occupies a portion of the pie chart and the switch pattern (from one product to another) is annotated. As illustrated, market segments s and c are located at different portions along the perimeter of the pie chart. Market segments may correspond to prescription drugs. Arrow 426A represents the switching pattern between the two market segments. In particular, arrow 426A shows 15 cases being switched from market segment s to c, with no cases in the reverse direction from market segment c to s.

FIG. 4G is an example of a flow chart for deriving usage pattern for patients based on linked prescription data. Initially, prescription data 441 is collected, for example, from data servers connected to pharmacies. Based on the received prescription data, a duration 442 is defined to further analyze the prescription data that correspond to 41,108 patient recipients. Next, the 1,100,012 prescription records in prescription data 441 are matched with the 41,108 patients. Often times, some patients have continuous prescription records during a time window while other do not. Duration adjustments 443 can be made based on the continuity of prescription records for each patient. Thereafter, episodes 444 (of treatments) may be identified from the 1,100,012 prescription records with regard to the 41,108 patients. Generally, a dominant therapy 445 may be identified for each episode. Here, 100% episodes include a dominant therapy. Subsequently, a categorization 446 of each individual patient may be made. The categorization may reveal a dosage pattern 447 of the patient, for example, whether the patient's dosage is escalating. The categorization may also lead to data view 440 that visualizes the usage pattern of the patients whose prescription records have been analyzed. The visualization may include a table form, as discussed below.

FIG. 4H shows an example of a table 450 tabulating the tracked usage pattern of patients for using healthcare products. Column 451 refers to specific patients referenced by their respective keys (for de-identification purposes). For illustrative purposes, the exact alphanumerical keys are replaced with simple numerals. As illustrated, the table shows the tracked usage pattern for five patients. Column 452 refers to the market segments, which can refer to specific prescription drugs or therapeutic areas covered by specific prescription drugs. Columns 453A to 453L represent the time points on which the usage patterns were tracked. Here, the dosage pattern for a market segment (e.g., a prescription drug) is tracked at the eleven time points for each of the five patients. The numbers are categorizations of patients (e.g. “11”=AddOn or “4”=“Repeat”, etc.). Data analytics revealed at such granularity naturally enable powerful insight into the usage patterns of each individual patient. The insight of the usage patterns of each individual patients may further strengthen the statistical characterization of the prescribing doctors.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method to identify healthcare professionals, the method comprising:
receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, and information indicating a time when the prescription was filled, the records devoid of information identifying patient recipients;
extracting, from the received prescription data, records of more than one healthcare professionals;
analyzing, by one or more processors coupled to the one or more database systems, the extracted records of each healthcare professional to rank the more than one healthcare professionals by:
determining, from the extracted records, a prescription volume for each healthcare professional;
generating, for each healthcare professional, a summary prescription pattern of patient recipients receiving prescriptions from the healthcare professional; and
classifying each healthcare professional according to the generated summary prescription pattern; and
providing, on a display device in communication with the one or more processors, information indicating at least one of the ranked healthcare professionals.

2. The method of claim 1, wherein generating the summary prescription pattern for each healthcare professional further comprises:
longitudinally linking, for each patient recipient who received prescriptions from the healthcare professional, records as extracted from the prescription data from the one or more database systems, wherein the prescriptions were received by the patient recipient at various times.

3. The method of claim 2, wherein generating the summary prescription pattern for each healthcare professional further comprises:
determining a respective usage pattern of each of the more than one patient recipients based on the linked records for more than one patient recipients who received prescriptions from the healthcare professional; and
generating the summary prescription pattern for the healthcare professional based on the aggregate usage patterns determined for the more than one patient recipients who received prescriptions from the healthcare professional.

4. The method of claim 3, wherein determining a respective usage pattern of a particular patient recipient further comprises:
determining whether the particular patient recipient is refilling a pharmaceutical product.

5. The method of claim 3, wherein determining a respective usage pattern of a particular patient recipient further comprises:
determining whether the particular patient recipient switched from a first pharmaceutical product to a second pharmaceutical product.

6. The method of claim 3, wherein determining a respective usage pattern of a particular patient recipient further comprises:
determining whether the particular patient recipient supplemented a first pharmaceutical product with a second pharmaceutical product.

7. The method of claim 3, wherein determining a respective usage pattern of a particular patient recipient further comprises:
determining whether the particular patient recipient received a pharmaceutical product from a given therapeutic class that the patient recipient had not previously received.

8. The method of claim 1, wherein analyzing the extracted records of each healthcare professional to rank more than one healthcare professionals further comprises:
determining a first group of patient recipients who received prescriptions from a first healthcare professional;
determining a second group of patient recipients who received prescriptions from a second healthcare professional, wherein the first and second healthcare professional are different from each other and both are from the more than one healthcare professionals being ranked; and
determining whether the first group overlaps with the second group.

9. The method of claim 8, further comprising:
in response to determining that the first group overlaps with the second group, determining a number of patient recipients in both the first group and the second group.

10. The method of claim 1, wherein analyzing the extracted records of each healthcare professional further comprises:
determining whether the healthcare professional is likely to use a newly launched healthcare product.

11. The method of claim 10, wherein determining whether the healthcare professional is likely to use a newly launched healthcare product further comprises:
determining whether the healthcare professional has used the newly launched healthcare product.

12. The method of claim 10, wherein determining whether the healthcare professional is likely to use a newly launched healthcare product further comprises:
determining whether the healthcare professional has used the newly launched healthcare product more often than at least one other healthcare professional.

13. A computer system comprising one or more processors, configured to perform the operations of:
receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, and information indicating a time when the prescription was filled, the records devoid of information identifying patient recipients;
extracting, from the received prescription data, records of more than one healthcare professionals;
analyzing, by one or more processors coupled to the one or more database systems, the extracted records of each healthcare professional to rank the more than one healthcare professionals by:
determining, from the extracted records, a prescription volume for each healthcare professional;
generating, for each healthcare professional, a summary prescription pattern of patient recipients receiving prescriptions from the healthcare professional; and
classifying each healthcare professional according to the generated summary prescription pattern; and
providing, on a display device in communication with the one or more processors, information indicating at least one of the ranked healthcare professionals.

14. The computer system of claim 13, wherein generating the summary prescription pattern for each healthcare professional further comprises:
longitudinally linking, for each patient recipient who received prescriptions from the healthcare professional, records as extracted from the prescription data from the one or more database systems, wherein the prescriptions were received by the patient recipient at various times.

15. The computer system of claim 14, wherein generating the summary prescription pattern for each healthcare professional further comprises:
determining a respective usage pattern of each of the more than one patient recipients based on the linked records for more than one patient recipients who received prescriptions from the healthcare professional; and
generating the summary prescription pattern for the healthcare professional based on the aggregate usage patterns determined for the more than one patient recipients who received prescriptions from the healthcare professional.

16. The computer system of claim 15, wherein determining a respective usage pattern of a particular patient recipient further comprises:
determining whether the particular patient recipient is refilling a pharmaceutical product.

17. The computer system of claim 15, wherein determining a respective usage pattern of a particular patient recipient further comprises:
determining whether the particular patient recipient switched from a first pharmaceutical product to a second pharmaceutical product.

18. The computer system of claim 15, wherein determining a respective usage pattern of a particular patient recipient further comprises:
determining whether the particular patient recipient supplemented a first pharmaceutical product with a second pharmaceutical product.

19. The computer system of claim 15, wherein determining a respective usage pattern of a particular patient recipient further comprises:
determining whether the particular patient recipient received a pharmaceutical product from a given therapeutical class that the particular patient recipient had not previously received.

20. The computer system of claim 13, wherein analyzing the extracted records of each healthcare professional to rank more than one healthcare professionals further comprises:
determining a first group of patient recipients who received prescriptions from a first healthcare professional;
determining a second group of patient recipients who received prescriptions from a second healthcare professional, wherein the first and second healthcare professional are different from each other and both are from the more than one healthcare professionals being ranked; and
determining whether the first group overlaps with the second group.

21. The computer system of claim 20, further comprising:
in response to determining that the first group overlaps with the second group, determining a number of patient recipients in both the first group and the second group.

22. The computer system of claim 13, wherein analyzing the extracted records of each healthcare professional further comprises:
determining whether the healthcare professional is likely to use a newly launched healthcare product.

23. The computer system of claim 22, wherein determining whether the healthcare professional is likely to use a newly launched healthcare product further comprises:
determining whether the healthcare professional has used the newly launched healthcare product.

24. The computer system of claim 22, wherein determining whether the healthcare professional is likely to use a newly launched healthcare product further comprises:
determining whether the healthcare professional has used the newly launched healthcare product more often than at least one other healthcare professional.

25. A computer-readable medium, comprising software instructions, which when executed by a processor of a computer, causes the computer to perform the operations of:
receiving, from one or more database systems each comprising non-volatile data storage devices, prescription data including records, each record encoding information identifying a pharmaceutical product, information identifying a healthcare professional prescribing the healthcare product, information referring to a patient recipient who received a prescription of the prescribed healthcare product from the healthcare professional, and information indicating a time when the prescription was filled, the records devoid of information identifying patient recipients;
extracting, from the received prescription data, records of more than one healthcare professionals;
analyzing, by one or more processors coupled to the one or more database systems, the extracted records of each healthcare professional to rank the more than one healthcare professionals by:
determining, from the extracted records, a prescription volume for each healthcare professional;
generating, for each healthcare professional, a summary prescription pattern of patient recipients receiving prescriptions from the healthcare professional; and
classifying each healthcare professional according to the generated summary prescription pattern; and
providing, on a display device in communication with the one or more processors, information indicating at least one of the ranked healthcare professionals.
